(19) United States
(12) Patent Application Publication
(10) Pub. No.: US 2001/0034874 A1
(43) Pub. Date: Oct. 25, 2001

(54) Network-based design service system and its design method

(76) Inventors: Toshio Yagihashi, Tokyo (JP); Shunichi Satou, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/828,889

(22) Filed: Apr. 10, 2001

(30) Foreign Application Priority Data
Apr. 19, 2000 (JP) 117975/2000

(51) Int. Cl. G06F 17/50

(52) U.S. Cl. 716/11

(57) ABSTRACT

In the network-based design service system of the present invention, a parts vendor registers on a design DB server various kinds of information, including the names of parts/vendor items, sample circuits, and design know-how, e.g., anti-noise circuits, in advance through a parts vendor terminal via a network, a designer performs circuit design for a device on a WWW site through a designer terminal, and an account terminal pays a royalty for the utilization of the design database from the bank account of the designer to the bank account of the parts vendor upon utilization of the design database, and pays an employment fee from the bank account of the parts vendor to the bank account of the designer upon employment of a part.

### BACKGROUNDS OF THE INVENTION

1. Field of the Invention

The present invention relates to a network-based design service system and its design method. In particular, the present invention relates to a network-based design service system and its design method for use in the design of main board, for example, circuit design for personal computer and the like.

2. Description of the Related Art

In conventional design services, a designer negotiates offline with parts manufacturers and other organizations throughout design process in order to realize a required design of a circuit or other part. For this, the designer has to make various other arrangements with parts manufacturers, etc., every time necessity arises to decide details of individual design items.

For example, a designer responsible for the design of a main board negotiates with parts vendors as to individual parts to be used for the planned main board, e.g., CPU, memory, I/O control, and display control, to select the most appropriate products in terms of performance, price, and other factors. The designer also decides the most appropriate anti-noise circuits, etc., for the respective parts, by taking into account the recommendation of parts manufacturers for achieving the required noise proof performance against static noise, reflective noise, cross talk noise, etc. The designer then combines the selected parts, and designs a main board offline, using a sample circuit as a basis.

These conventional design service systems have problems of inefficiency and inconvenience because they force the designer to design a circuit, etc., by negotiating offline with parts manufacturers and other organizations concerning individual design items, making design tasks very onerous and time-consuming.

### SUMMARY OF THE INVENTION

One object of the present invention is to provide a design service system and its design method for real-time design, thereby contributing to a considerable improvement in design efficiency.

Another object of the present invention is to provide a system that allows a designer to access a design database online and make payments over a network for the utilization of the design database.

According to the first aspect of the invention, a network-based design service system, comprises

design database server for storing a design database containing information on parts/vendors, information on sample circuits, and information on antinoise circuit and other design know-how that are registered by a parts vendor in advance via a network,

designer terminal for a designer to search the design database, determine design conditions autonomously, and conduct the design of a device, and

account terminal for paying a royalty for utilizing the design database from the bank account of the designer to the bank account of the parts vendor upon utilization of the design database.

In the preferred construction, the designer terminal searches the design database on a WWW site, determines design conditions autonomously, and conducts the design of a device.

In another preferred construction, the account terminal has a function for paying an employment fee from the bank account of the parts vendor to the bank account of the designer upon employment of a part by the designer.

In another preferred construction, the network-based design service system further comprises means for notifying a problem if a problem is found in a sample circuit, etc., during the design process for a device to other designer terminals being used by other designers working on the devices related to the device with the problem.

In another preferred construction, the network-based design service system further comprises means for the designer to conduct circuit design for a device, and determine parts to employ autonomously through price simulation for achieving the target price of the device and noise simulation for achieving the required noise proof performance.

In another preferred construction, the network-based design service system further comprises means for notifying a problem found in a sample circuit, etc., during the design process for a device, if any, to other designer terminals being used by other designers working on the devices related to the device with the problem, and means for the designer to conduct circuit design for a device, and determine parts to employ autonomously through price simulation for achieving the target price of the device and noise simulation for achieving the required noise proof performance.

According to the second aspect of the invention, a network-based design method, comprising the steps of

a parts vendor registering on a design database server various kinds of information, including information on parts/vendors, information on sample circuits, and information on anti-noise circuit and other design know-how, in advance via a network,

a designer searching the design database, determining design conditions autonomously, and conducting the design of a device, and

paying a royalty for utilizing the design database from the bank account of the designer to the bank account of the parts vendor upon utilization of the design database.

In the preferred construction, the design step searches the design database on a WWW site, determines design conditions autonomously, and conducts the design of a device.

In another preferred construction, the network-based design method further comprising the step of

paying an employment fee from the bank account of the parts vendor to the bank account of the designer upon employment of a part by the designer.

In another preferred construction, the network-based design method further comprising the step of

notifying a problem if a problem is found in a sample circuit, etc., during the design process for a device to other designer terminals being used by other designers working on the devices related to the device with the problem.

In another preferred construction, the network-based design method further comprising the step of

the designer conducting circuit design for a device, and determine parts to employ autonomously through price simulation for achieving the target price of the device and noise simulation for achieving the required noise proof performance.

In another preferred construction, the network-based design method further comprising the step of

notifying a problem if a problem is found in a sample circuit, etc., during the design process for a device to other designer terminals being used by other designers working on the devices related to the device with the problem, and

the designer conducting circuit design for a device, and determine parts to employ autonomously through price simulation for achieving the target price of the device and noise simulation for achieving the required noise proof performance.

According to another aspect of the invention, a network-based design service system, comprises

design database server for storing a design database containing information on parts/vendors, information on sample circuits, and information on anti-noise circuit and other design know-how that are registered by a parts vendor in advance via a network, and

designer terminal for a designer to search the design database, determine design conditions autonomously, and conduct the design of a device.

In the preferred construction, the designer terminal searches the design database on a WWW site, determines design conditions autonomously, and conducts the design of a device.

In another preferred construction, the network-based design service system further comprises

means for notifying a problem if a problem is found in a sample circuit, etc., during the design process for a device to other designer terminals being used by other designers working on the devices related to the device with the problem.

In another preferred construction, the network-based design service system further comprises

means for the designer to conduct circuit design for a device, and determine parts to employ autonomously through price simulation for achieving the target price of the device and noise simulation for achieving the required noise proof performance.

In another preferred construction, the network-based design service system further comprises

means for notifying a problem if a problem is found in a sample circuit, etc., during the design process for a device to other designer terminals being used by other designers working on the devices related to the device with the problem, and

means for the designer to conduct circuit design for a device, and determine parts to employ autonomously through price simulation for achieving the target price of the device and noise simulation for achieving the required noise proof performance.

In the present invention, as described briefly above, a parts vendor registers on a design DB server various kinds of information, including the names of parts/vendor items, sample circuits, and design know-how, e.g., anti-noise circuits, in advance through a parts vendor terminal via a network; a designer can then perform circuit design for a device on a WWW site through a designer terminal. Upon utilization of the design database, an account terminal pays a royalty for the utilization of the design database from the bank account of the designer to the bank account of the parts vendor. Upon employment of a part, the account terminal pays an employment fee for the selected part from the bank account of the parts vendor to the bank account of the designer. The present invention allows the preferred part to be determined autonomously, thereby making it possible for a designer to perform real-time design and consequently contributing to a considerable improvement in design efficiency.

The present invention eliminates the inconvenience on the part of a designer addressing this kind of design, which arises from being forced to negotiate with a parts manufacturer offline as occasion demands. The present invention also provides a significant improvement in design efficiency by allowing a designer to conduct real-time design, based on the design database featuring unified and comprehensive coverage of design know-how. As compensation for these benefits enjoyed by a designer, a royalty for the utilization of the design database can be paid from the bank account of the designer to the bank account of the parts vendor after the design database has been utilized. After a part has been employed, on the other hand, an employment fee for the selected part can be paid from the bank account of the parts vendor to the bank account of the designer.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing an embodiment of a network-based design service system and its design method according to the present invention;

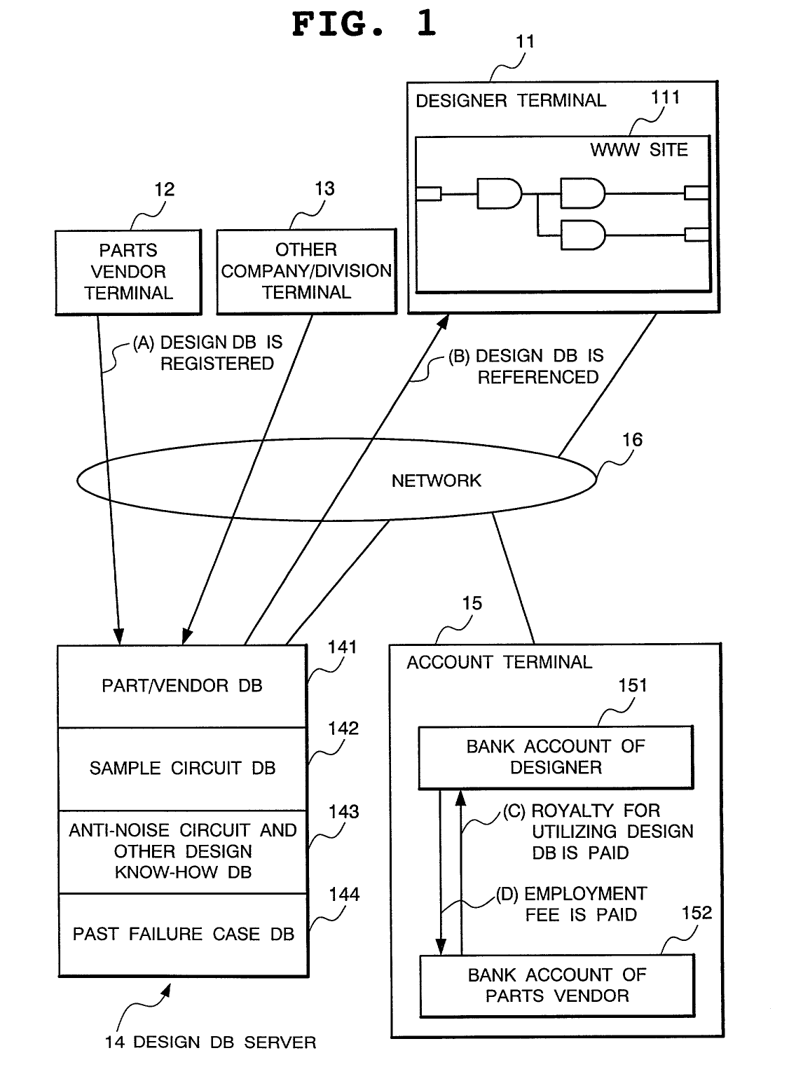

FIG. 2 is a block diagram showing a sample configuration of designer terminal, parts vendor terminal, and other company/division terminal according to the present embodiment;

FIG. 3 is a diagram showing a sample configuration of design DB according to the present embodiment;

FIG. 4 is a diagram showing an example of anti-noise measure for main board;

FIG. 5 is a flow chart describing the operation of a network-based design service system and its design method according to the present embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

A system according to the present embodiment comprises a parts vendor terminal 12 for supplying parts of a device; an other company/division terminal 13; a database of parts and vendors registered by a parts vendor via a network 16 (part/vendor DB) 141; a database of sample circuits (sample circuit DB) 142; a database of anti-noise circuit and other design know-how (anti-noise circuit and other design know-how DB) 143; a design database server (design DB server) 14 for storing a design database (design DB) consisting of a database of past failure cases (past failure case DB) 144 and other information; one or more designer terminals 11 for a designer to design a device on a WWW site using said design DB as a basis; and an account terminal 15 for paying a royalty (C) for utilizing said design DB from a designer bank account 151 to parts vendor bank account 152 upon utilization of said design DB by the designer, and pays an employment fee (D) from the parts vendor bank account 152 to the designer bank account 151 upon employment of a part.

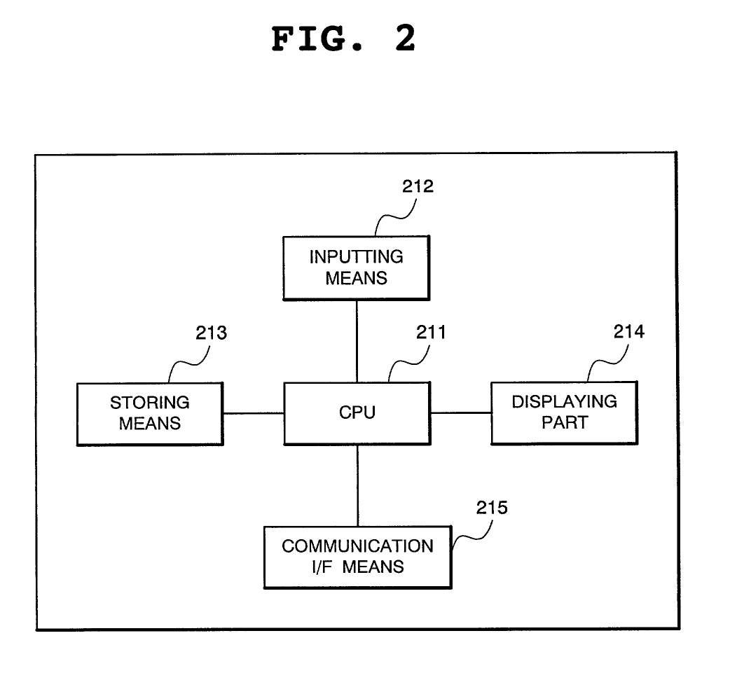

FIG. 2 is a block diagram showing a sample configuration of designer terminal 11, parts vendor terminal 12, and other company/division terminal 13. This configuration comprises an inputting means 212, such as a keyboard (KB); a CPU 211, such as a microprocessor; a displaying part 214, such as an LCD display; a storing means 213 for storing data; and a communication I/F means 215 for connecting to the Internet or other network.

The design DB server 14 has a function for accepting registrations (A) of information for inclusion in the design DB through the parts vendor terminal 12 and the other company/division terminal 13, and the function of providing the information to the designer terminal 11.

The designer terminal 11 has a function for extracting, selecting and displaying circuit parts, or a sample circuit that is a combination thereof, for a certain device design; a simulating function for simulating a calculation of the prices of all the parts used in a designed circuit; a noise simulating function for simulating various kinds of noise, for example, reflective noise in the designed circuit and cross talk between circuit wiring patterns; and an autonomous part extracting function for selecting another part with a different price or another preferred part to a higher accuracy specification if said two simulations show that the target values are not achieved.

In addition, the designer terminal 11 has a notifying function for notifying a problem, if one is found in a sample circuit, etc., through said simulations during the design process for a device, to other designer terminals being used by other designers working on the devices related to the device with such problem, for example, a circuit board to be connected with the device with such problem. Either the parts vendor terminal 12 or the other company/division terminal 13 can also be configured to include said function.

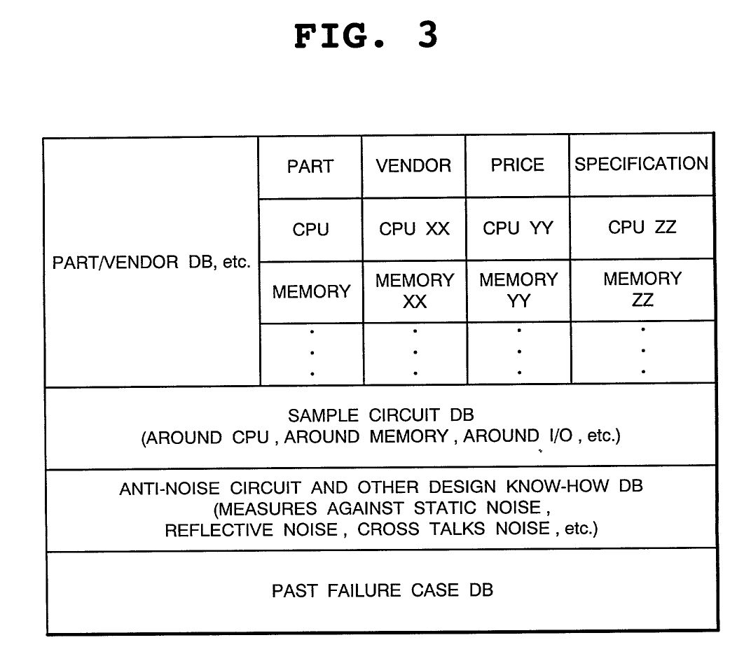

FIG. 3 is a diagram showing a sample configuration of design DB. The design DB stores a part/vendor DB, a sample circuit DB, an anti-noise circuit and other design know-how DB, past failure cases, and other information.

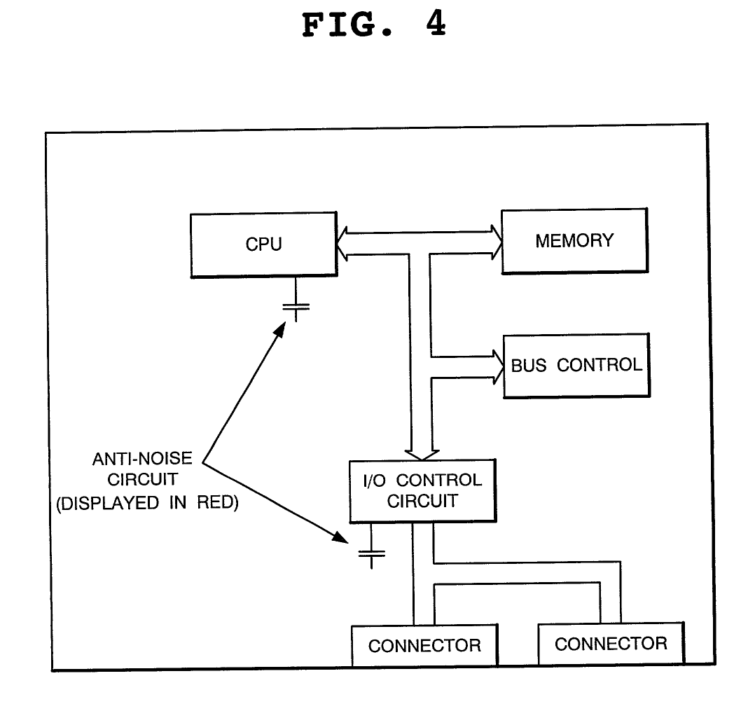

FIG. 4 is a diagram showing an example of anti-noise measure for main board to be stored in the design DB. In this diagram, the anti-noise measure connected to each circuit part is shown as a concrete circuit means. In the example of FIG. 4, the anti-noise circuit is displayed in a color that is different from the color used for the base circuit, e.g., the sample circuit, but is based on the color of the sample circuit, thereby facilitating the identification of the anti-noise circuit.

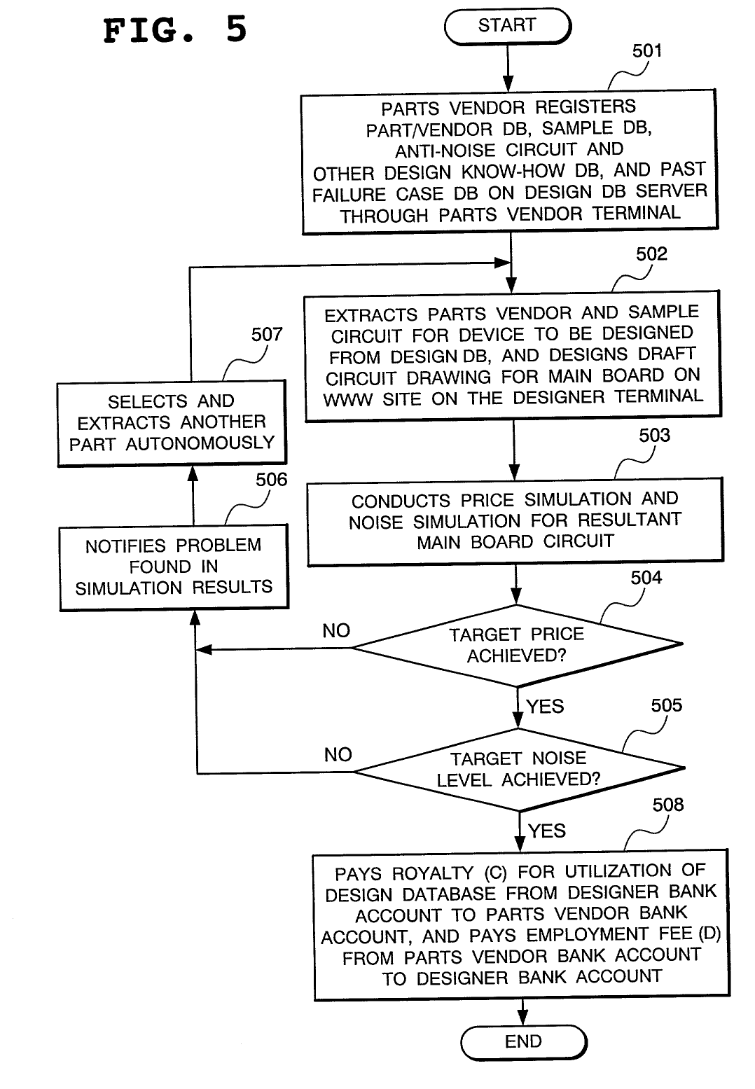

FIG. 5 is a flow chart describing the operation of a network-based design service system according to the present embodiment. Based on this flow chart, and also with reference to FIGS. 3 and 4, the system of the present embodiment will be described in detail below.

First, the parts vendor registers its design data DB on the design DB server 14 (Step 501). This means that the parts vendor registers (A) a design DB, consisting of a part/vendor DB 141, a sample DB 142, an anti-noise circuit and other design know-how DB 143, a past failure case DB 144, and other information, through the inputting means 212, e.g., keyboard (KB), of the parts vendor terminal 12 on the design DB server 14.

As shown in the sample configuration of design DB of FIG. 3, the part/vendor DB in the design DB stores a list of parts used in the main board, e.g., CPU, memory, and I/O control chip, and the respective specifications and other information, including vendor name, vendor price, and performance/size.

The sample circuit DB in the design DB stores the circuits of main boards for other devices, the circuits of existing designs, etc. The anti-noise circuit and other design know-how DB stores design know-how addressing static noise, radial noise, power source noise, cross talk between circuit wiring patterns, and other noise-related problems. The past failure case DB in the design DB stores various failure cases experienced in the past.

In the following design step, the designer references and extracts (B) from the design DB server (14) information concerning parts vendors and sample circuits for the device to be designed, using the designer terminal 11. The designer then designs a draft circuit drawing for the main board on a WWW site displayed on the designer terminal (11) (Step 502). Selection of component parts by the designer during the design process on the WWW site is conducted through an interactive interface.

Following this, a simulation is performed to calculate the total price of all the parts in the main board circuit above (Step 503). The result of this simulation is then checked to see whether it meets the initial target price of the design (Step 504). If not, sample circuit and other parts are re-selected. If a problem is found from the result of the simulation, etc., such problem is notified to other designer terminals being used by other designers working on the devices related to the device with such problem, for example, a circuit board to be connected with the device with such problem (Step 506). In addition, another product with a different price is selected and extracted automatically (autonomously) (Step 507).

If the initial target price of the design is met, a noise proof simulation is performed to determine reflective noise, cross talk between circuit wiring patters, and other condition within the main board circuit (Step 505). If the result of this simulation does not meet the requirement of noise proof performance, an anti-noise circuit or other measure is added, modified, or corrected. When doing this, it is ensured that the anti-noise circuit is displayed using a color that is different from the color used for the base circuit, e.g., the sample circuit, but is based on the color of the sample circuit, thereby facilitating the identification of the anti-noise circuit.

If a problem is found from the result of the simulation, etc., such problem is notified to other designer terminals being used by other designers working on the devices related to the device with such problem, for example, a circuit board to be connected with the device with such problem (Step 506). In addition, another product to a higher accuracy specification is selected and extracted automatically (autonomously) (Step 507).

If these two simulations show that the target values are achieved, payment process is conducted to pay a royalty (C) for utilizing said design DB from a designer bank account 151 to parts vendor bank account 152 upon utilization of said design DB by the designer. Payment process is also conducted to pay an employment fee (D) from the parts vendor bank account 152 to the designer bank account 151 upon employment of a part (Step 508).

The steps described above can achieve a significant improvement in design efficiency by having a parts vendor register on a design DB server various kinds of information, including the names of parts/vendor items, sample circuits, and design know-how, e.g., anti-noise circuits, in advance through a parts vendor terminal via a network, and also having the preferred parts be selected autonomously while a designer is performing circuit design for a device on a WWW site.

According to the present invention, it is possible to achieve a significant improvement in design efficiency because a designer can design on a real-time basis, based on a design database featuring unified and comprehensive coverage of design know-how. By this, the present invention can eliminate the inconvenience on the part of a designer addressing this kind of design, which arises from being forced to negotiate with a parts manufacturer offline to make arrangements concerning individual design items as occasion demands.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A network-based design service system, comprising:
design database server for storing a design database containing information on parts/vendors, information on sample circuits, and information on anti-noise circuit and other design know-how that are registered by a parts vendor in advance via a network;
designer terminal for a designer to search said design database, determine design conditions autonomously, and conduct the design of a device; and
account terminal for paying a royalty for utilizing the design database from the bank account of the designer to the bank account of the parts vendor upon utilization of said design database.

2. The network-based design service system as set forth in claim 1, wherein
said designer terminal searches said design database on a WWW site, determines design conditions autonomously, and conducts the design of a device.

3. The network-based design service system as set forth in claim 1, wherein
said account terminal has a function for paying an employment fee from the bank account of the parts vendor to the bank account of the designer upon employment of a part by said designer.

4. The network-based design service system as set forth in claim 1, comprising:
means for notifying a problem if a problem is found in a sample circuit, etc., during the design process for a device to other designer terminals being used by other designers working on the devices related to the device with said problem.

5. The network-based design service system as set forth in claim 1, comprising:
means for the designer to conduct circuit design for a device, and determine parts to employ autonomously through price simulation for achieving the target price of the device and noise simulation for achieving the required noise proof performance.

6. The network-based design service system as set forth in claim 1, comprising:
means for notifying a problem found in a sample circuit, etc., during the design process for a device, if any, to other designer terminals being used by other designers working on the devices related to the device with said problem; and
means for the designer to conduct circuit design for a device, and determine parts to employ autonomously through price simulation for achieving the target price of the device and noise simulation for achieving the required noise proof performance.

7. A network-based design method, comprising the steps of:
a parts vendor registering on a design database server various kinds of information, including information on parts/vendors, information on sample circuits, and information on anti-noise circuit and other design know-how, in advance via a network;
a designer searching said design database, determining design conditions autonomously, and conducting the design of a device; and
paying a royalty for utilizing the design database from the bank account of the designer to the bank account of the parts vendor upon utilization of said design database.

8. The network-based design method as set forth in claim 7, wherein
said design step searches said design database on a WWW site, determines design conditions autonomously, and conducts the design of a device.

9. The network-based design method as set forth in claim 7, further comprising the step of:
paying an employment fee from the bank account of the parts vendor to the bank account of the designer upon employment of a part by said designer.

10. The network-based design method as set forth in claim 7, comprising the step of:
notifying a problem if a problem is found in a sample circuit, etc., during the design process for a device to other designer terminals being used by other designers working on the devices related to the device with said problem.

11. The network-based design method as set forth in claim 7, comprising the step of:
the designer conducting circuit design for a device, and determine parts to employ autonomously through price simulation for achieving the target price of the device and noise simulation for achieving the required noise proof performance.

12. The network-based design method as set forth in claim 7, comprising the steps of:
notifying a problem if a problem is found in a sample circuit, etc., during the design process for a device to other designer terminals being used by other designers working on the devices related to the device with said problem; and
the designer conducting circuit design for a device, and determine parts to employ autonomously through price simulation for achieving the target price of the device and noise simulation for achieving the required noise proof performance.

13. A network-based design service system, comprising:
design database server for storing a design database containing information on parts/vendors, information on sample circuits, and information on anti-noise circuit and other design know-how that are registered by a parts vendor in advance via a network; and
designer terminal for a designer to search said design database, determine design conditions autonomously, and conduct the design of a device.

14. The network-based design service system as set forth in claim 13, wherein
said designer terminal searches said design database on a WWW site, determines design conditions autonomously, and conducts the design of a device.

15. The network-based design service system as set forth in claim 13, comprising:
means for notifying a problem if a problem is found in a sample circuit, etc., during the design process for a device to other designer terminals being used by other designers working on the devices related to the device with said problem.

16. The network-based design service system as set forth in claim 13, comprising:
means for the designer to conduct circuit design for a device, and determine parts to employ autonomously through price simulation for achieving the target price of the device and noise simulation for achieving the required noise proof performance.

17. The network-based design service system as set forth in claim 13, comprising:
means for notifying a problem if a problem is found in a sample circuit, etc., during the design process for a device to other designer terminals being used by other designers working on the devices related to the device with said problem; and
means for the designer to conduct circuit design for a device, and determine parts to employ autonomously through price simulation for achieving the target price of the device and noise simulation for achieving the required noise proof performance.
